(19) United States
(12) Patent Application Publication
(10) Pub. No.: US 2026/0073562 A1
(43) Pub. Date: Mar. 12, 2026

(54) CALIBRATING A SECOND VEHICLE CAMERA BASED ON CALIBRATION INFORMATION OF A CALIBRATED FIRST CAMERA IN A CAMERA HOUSING

(71) Applicant: Volvo Truck Corporation, Göteborg (SE)

(72) Inventors: Nicolas Berne, Heyrieux (FR); Azize Davis, Torslanda (SE)

(21) Appl. No.: 19/311,709

(22) Filed: Aug. 27, 2025

(30) Foreign Application Priority Data
Sep. 12, 2024 (EP) 24199904.4

(51) Int. Cl. G06T 7/80; B60R 1/23

(52) U.S. Cl. CPC G06T 7/80; B60R 1/23; B60R 2300/105; B60R 2300/402; G06T 2207/30244; G06T 2207/30252

(57) ABSTRACT

A vehicle includes an imaging system including a first camera and a second camera in a housing mounted to the vehicle, and a processing circuit that uses a first calibration information obtained from a calibration of the first camera to generate a second calibration information to calibrate the second camera. The first calibration information identifies a first position difference between a position of the first camera and a reference position, and also identifies a first orientation difference between an orientation of the first camera and a reference orientation. The second calibration information includes a second position difference between the second camera and the reference position, and a second orientation difference between the second camera and the reference orientation. Generating the second calibration information includes combining the first calibration information with translation information providing a position difference and an orientation difference between the first camera and the second camera.

### PRIORITY APPLICATIONS

The present application claims priority to European Patent Application No. 24199904.4, filed on September 12, 2024, and entitled “CALIBRATING A SECOND VEHICLE CAMERA BASED ON CALIBRATION INFORMATION OF A CALIBRATED FIRST CAMERA IN A CAMERA HOUSING,” which is incorporated herein by reference in its entirety.

### TECHNICAL FIELD

The disclosure relates generally to improving vehicle safety. In particular aspects, the disclosure relates to a system for calibrating an uncalibrated camera in a camera housing for an imaging system in a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Cameras may be provided on vehicles to increase driver awareness of their surroundings and to provide image information to automated driver assistance functions in vehicles, such as blind-spot detectors, backup sensors, and automatic braking. Cameras may be particularly helpful in larger vehicles, around which driver visibility may be limited. The image information provided by a camera may be misleading, unhelpful, or difficult to interpret, depending on the positioning and direction of the camera. Since image information may be used to control automated driver assistance functions to improve vehicle safety, it is important for the imaging system to provide expected image information (e.g., from an expected perspective relative to the vehicle). Camera calibration ensures that the image information provided to the driver and/or to image processing software is expected image information. However, the task of performing a calibration consumes time and other resources, which increases cost.

### SUMMARY

Aspects disclosed herein include calibrating a second vehicle camera based on calibration information of a calibrated first camera in a camera housing. Methods of calibrating a camera in a same housing as a calibrated camera are also disclosed. An imaging system of a vehicle includes on or more cameras providing image information to a driver or image processor for vehicle related functions. Cameras secured in a camera housing mounted on a vehicle are expected to provide image information from a particular view of the vehicle surroundings, from a particular perspective and orientation (e.g., relative to the vehicle). For example, a vehicle can include multiple cameras that are supported in a common housing, but oriented differently in the housing to capture images in different directions to provide imaging information in different directions for vehicle related functions. For example, a second camera be a camera-monitoring system (CMS) camera that may be required to meet a different operating standard than an advanced driving assistance system (ADAS) camera and may be used for different purposes than the ADAS camera. There can be non-uniformities in camera housings due to manufacturing processes, in addition to variations involving mounting the housings to vehicles. A result of such non-uniformities is that the image information from cameras in a housing may not be as expected due to the camera being in an unexpected position and/or orientation. A camera position is defined as its position in a three-dimensional (3D) space, which may be measured relative to the vehicle. A difference between an actual camera position and a reference position can be identified by distances in the three dimensions. A camera orientation is the direction of view (e.g., focal point) relative to the reference position, which may be defined as angles relative to a set of axes (X-Y-Z) of a 3D space. A difference between an actual camera orientation and a reference orientation may also be defined as angles, referred to as pitch, yaw, and roll, as known to aviators. A calibration process can determine the difference between a camera position and the reference position, and the difference between a camera orientation and the reference orientation. The calibration information can be used to calibrate the camera, which includes adjusting the image information provided by the camera to provide the view expected by the driver and/or image processor. Without calibration, the image information can be inaccurate or misleading, which can reduce the safety benefits provided by an imaging system on a vehicle. Also, if multiple cameras are provided in a vehicle, each of the cameras need to be calibrated, which can be time consuming and expensive.

In this regard, to reduce calibration time and expense, in exemplary aspects disclosed herein, a vehicle is provided that includes an imaging system including a first camera and a second camera in a housing mounted to the vehicle. The vehicle includes a processing circuit that uses a first calibration information obtained from a calibration of the first camera to generate a second calibration information to calibrate the second camera. The first calibration information identifies a first position difference between an actual position of the first camera and a reference position and also identifies a first orientation difference between an actual orientation of the first camera and a reference orientation. The second calibration information includes a second position difference between an actual position of the second camera and the reference position and identifies a second orientation difference between an actual orientation of the second camera and the reference orientation. Generating the second calibration information includes combining the first calibration information with translation information providing a position difference and an orientation difference between the first camera and the second camera. Calibrating the second camera in this manner, rather than by known calibration processes, improves the accuracy of image information from the second camera, which improves vehicle safety, in less time and expense. In some examples, the translation information may be manufacturing (e.g., computer aided design (CAD)) information of the camera housing or measurements of an actual housing.

According to a first aspect of the disclosure, a vehicle including an imaging system is disclosed. The imaging system includes a housing mounted to the vehicle, a first camera disposed in a first position in the housing and a first orientation relative to the first position, a second camera disposed in a second position in the housing and a second orientation relative to the second position, and a processing circuit configured to receive a first calibration information for the first camera. The processing circuit is further configured to receive translation information including a position difference between the first position of the first camera and the second position of the second camera, and an orientation difference between the first orientation and the second orientation. The processing circuit is further configured to generate, based on the first calibration information and the translation information, a second calibration information for calibrating the second camera.

The first aspect of the disclosure may seek to improve the image information provided by a second camera in a housing with a calibrated first camera. A technical benefit may include improving the accuracy of image information from the second camera, which improves vehicle safety, and avoids the need for time-consuming and costly methods of calibrating the second camera.

Optionally in some examples, including in at least one preferred example, the second camera is configured to receive second image information, and the processing circuit is further configured to generate calibrated second image information based on the second image information and the second calibration information. A technical benefit may include adjusting the image information from an uncalibrated camera using the calibration information generated in the first camera.

Optionally in some examples, including in at least one preferred example, the processing circuit is further configured to generate the calibrated second image including a target area of the second image information, and center the target area in the calibrated image based on the second calibration information. A technical benefit may include improving the image information obtained from the second camera based on image information from the first camera.

Optionally in some examples, including in at least one preferred example, the first camera includes an advanced driving assistance system (ADAS) camera, and the second camera includes a camera-monitor system (CMS) camera. A technical benefit may include improving the image information of a CMS camera by using the calibration information of an ADAS camera.

Optionally in some examples, including in at least one preferred example, the translation information includes design information for manufacturing the housing. A technical benefit may include using pre-existing information rather than incurring the cost of calibration to improve image information.

Optionally in some examples, including in at least one preferred example, the processing circuit is further configured to receive first image information from the first camera and generate translation information based on the first image information and the second image information. A technical benefit may include developing the translation information in the processing circuit as opposed to relying on translation information from an external source.

Optionally in some examples, including in at least one preferred example, the position difference includes distances in three directions that are orthogonal to each other between the first position and the second position. A technical benefit may include using these distances to determine the position of the second camera from the position of the first camera to determine differences in perspective.

Optionally in some examples, including in at least one preferred example, the orientation difference includes a pitch, a yaw, and a roll angle between the first orientation and the second orientation. A technical benefit may include using these angles to determine the orientation of the second camera from the orientation of the first camera.

Optionally in some examples, including in at least one preferred example, the second position of the second camera includes a position difference between the first position of the first camera and a reference position, and a position difference between the second position of the second camera and the first position of the first camera. A technical benefit may include using known position difference information of the first camera to determine a position of the second camera.

Optionally in some examples, including in at least one preferred example, the second orientation of the second camera includes an orientation difference between the first camera and a reference orientation, and an orientation difference between the second camera and the first camera. A technical benefit may include using a known orientation of the first camera to determine an orientation of the second camera without calibration.

Optionally in some examples, including in at least one preferred example, the housing is attached to one of a driver side and a passenger side of the vehicle. A technical benefit may include improving safety by providing views adjacent to the vehicle.

According to a second aspect of the disclosure, a method for calibrating a camera is disclosed. The method includes receiving a first calibration information for a first camera disposed in a first position in a housing and having a first orientation. The method further includes receiving translation information including a position difference between the first position of the first camera and a second position of a second camera disposed in the housing, and an orientation difference between the first orientation of the first camera and a second orientation of the second camera. The method further includes generating, based on the first calibration information and the translation information, a second calibration information for calibrating the second camera.

The second aspect of the disclosure may seek to provide a method for improving the image information of a second camera in a housing without calibration. A technical benefit may include improving the image information of the second camera based on a calibrated first camera.

Optionally in some examples, including in at least one preferred example, the method further includes receiving a second image information from the second camera, and generating a calibrated image based on the second image information and the second calibration information. A technical benefit may include improving the image information of the second camera based on the calibration information determined for the second camera without calibration.

Optionally in some examples, including in at least one preferred example, the method further includes generating the calibrated image based on a target area of the second image information, and centering the target area in the calibrated image based on the second calibration information. A technical benefit may include improving the image information obtained from the second camera based on image information from the first camera.

Optionally in some examples, including in at least one preferred example, the method further includes extracting the translation information from design information for manufacturing the housing. A technical benefit may include using pre-existing information rather than incurring the cost of calibration to improve image information.

Optionally in some examples, including in at least one preferred example, the method further includes examining the housing to determine the translation information. A technical benefit may include avoiding the need for calibration by examining the housing

Optionally in some examples, including in at least one preferred example, the method further includes determining the translation information based on differences between the first image information and the second image information. A technical benefit may include avoiding the need for calibration by comparing the images of the two cameras.

Optionally in some examples, including in at least one preferred example, the method further includes determining a position difference between the first position of the first camera and a reference position, and determining a position difference between the second position of the second camera and the first position of the first camera. A technical benefit may include using known position differences of the first camera to identify a position of the second camera.

Optionally in some examples, including in at least one preferred example, the method further includes determining an orientation difference between the first orientation of the first camera and a reference orientation, and determining an orientation difference between the second camera and the first camera. A technical benefit may include using known orientation information of the first camera to determine an orientation of the second camera.

According to a third aspect of the disclosure, a non-transitory computer-readable storage medium is disclosed. The non-transitory computer-readable storage medium includes instructions, which when executed by a processing circuit, cause the processing circuit to receive a first calibration information for a first camera disposed in a first position in a housing and having a first orientation. The instructions further cause the processing circuit to receive translation information including a position difference between the first position of the first camera and a second position of a second camera disposed in the housing, and an orientation difference between the first orientation of the first camera and a second orientation of the second camera. The instructions further cause the processing circuit to generate, based on the first calibration information and the translation information, a second calibration information for calibrating the second camera.

The third aspect of the disclosure may seek to improve the image information provided by a second camera in a housing with a calibrated first camera. A technical benefit may include avoiding the need to calibrate the second camera.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIGS. 1A and 1B are a front view and a side view, respectively, of an exemplary vehicle including an imaging system including two cameras in a housing and processing circuity to calibrate one camera based on calibration information of the other camera;

FIG. 2 is an example of the housings in FIGS. 1A and 1B, in which cameras may be collocated and one may be calibrated based on calibration information of another;

FIG. 3 is an illustration of another example of a housing as shown in FIGS. 1A, 1B, and 2, to show relative positions of two cameras in a housing and the respective orientations from which they receive image information;

FIG. 4 is a flow chart of a method of calibrating a second camera based on calibration information of a first calibrated camera collocated in a housing;

FIG. 5 is an example of overlaid images that may be received in a camera due to manufacturing tolerances of a housing, illustrating the need for camera calibration;

FIG. 6 is a schematic diagram of a system for calibrating a first camera based on calibration information of a second camera collocated in a housing, as disclosed herein; and

FIG. 7 is a view of a computer system for implementing details disclosed herein and may be the processing circuit in FIGS. 1A, 1B, and 6.

### DETAILED DESCRIPTION

The detailed description set forth below provides information and examples of the disclosed technology with sufficient detail to enable those skilled in the art to practice the disclosure.

Aspects disclosed herein include calibrating a second vehicle camera based on calibration information of a calibrated first camera in a camera housing. Methods of calibrating a camera in a same housing as a calibrated camera are also disclosed. An imaging system of a vehicle includes on or more cameras providing image information to a driver or image processor for vehicle related functions. Cameras secured in a camera housing mounted on a vehicle are expected to provide image information from a particular view of the vehicle surroundings, from a particular perspective and orientation (e.g., relative to the vehicle). For example, a vehicle can include multiple cameras that are supported in a common housing, but oriented differently in the housing to capture images in different directions to provide imaging information in different directions for vehicle related functions. For example, a second camera be a camera-monitoring system (CMS) camera that may be required to meet a different operating standard than an advanced driving assistance system (ADAS) camera and may be used for different purposes than the ADAS camera. There can be non-uniformities in camera housings due to manufacturing processes, in addition to variations involving mounting the housings to vehicles. A result of such non-uniformities is that the image information from cameras in a housing may not be as expected due to the camera being in an unexpected position and/or orientation. A camera position is defined as its position in a three-dimensional (3D) space, which may be measured relative to the vehicle. A difference between an actual camera position and a reference position can be identified by distances in the three dimensions. A camera orientation is the direction of view (e.g., focal point) relative to the reference position, which may be defined as angles relative to a set of axes (X-Y-Z) of a 3D space. A difference between an actual camera orientation and a reference orientation may also be defined as angles, referred to as pitch, yaw, and roll, as known to aviators. A calibration process can determine the difference between a camera position and the reference position, and the difference between a camera orientation and the reference orientation. The calibration information can be used to calibrate the camera, which includes adjusting the image information provided by the camera to provide the view expected by the driver and/or image processor. Without calibration, the image information can be inaccurate or misleading, which can reduce the safety benefits provided by an imaging system on a vehicle. Also, if multiple cameras are provided in a vehicle, each of the cameras need to be calibrated, which can be time consuming and expensive.

In this regard, to reduce calibration time and expense, in exemplary aspects disclosed herein, a vehicle is provided that includes an imaging system including a first camera and a second camera in a housing mounted to the vehicle. The vehicle includes a processing circuit that uses a first calibration information obtained from a calibration of the first camera to generate a second calibration information to calibrate the second camera. The first calibration information identifies a first position difference between an actual position of the first camera and a reference position and also identifies a first orientation difference between an actual orientation of the first camera and a reference orientation. The second calibration information includes a second position difference between an actual position of the second camera and the reference position and identifies a second orientation difference between an actual orientation of the second camera and the reference orientation. Generating the second calibration information includes combining the first calibration information with translation information providing a position difference and an orientation difference between the first camera and the second camera. Calibrating the second camera in this manner, rather than by known calibration processes, improves the accuracy of image information from the second camera, which improves vehicle safety, in less time and expense. In some examples, the translation information may be manufacturing (e.g., computer aided design (CAD)) information of the camera housing or measurements of an actual housing.

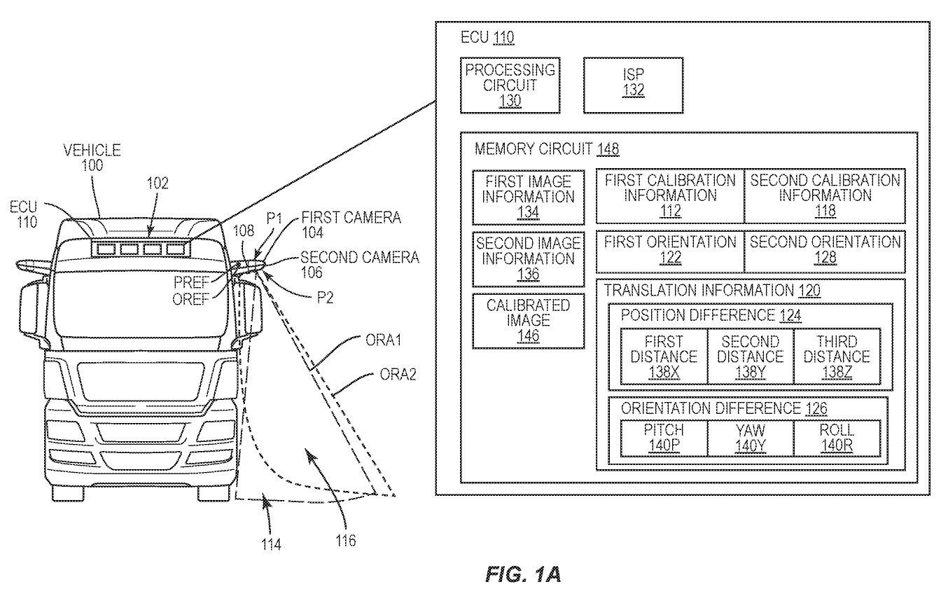

FIGS. 1A and 1B are illustrations of a front view and a side view, respectively, of an exemplary vehicle 100 (e.g., a tractor-trailer). The vehicle 100 includes an imaging system 102 including a first camera 104 and a second camera 106 that are both disposed in a housing 108 on the vehicle 100.

It has become more common for vehicles, such as the vehicle 100, to include cameras for improved safety. Some vehicle cameras adhere to certain safety standards, which may be required to meet road safety regulations, for example. In this regard, in some examples, the first camera 104 may be an advanced driving assistance system (ADAS) camera that may be calibrated according to a known method. Calibration of an ADAS camera may employ a specialized calibration facility and/or a calibration apparatus, as well as calibration software that may be executed in an electronic control unit (ECU) 110 in the vehicle 100 or an external computing device. The calibration process generates a first calibration information 112, which may be used in the imaging system 102 to adjust the information provided by the first camera to provide an expected view. In some examples, the second camera 106 may be a camera-monitoring system (CMS) camera that may be required to meet a different operating standard than the ADAS camera and may be used for different purposes than the ADAS camera. Using a common housing for both cameras avoids the need for a second housing, which simplifies manufacturing and reduces vehicle cost. A common housing also allows both cameras to have the benefit of an optimum viewpoint from the vehicle.

As shown in FIGS. 1A and 1B, a first field of view 114 for the first camera 104 may be different from a second field of view 116 of the second camera 106. This may be because the first camera 104 and the second camera 106 are employed for different purposes (e.g., ADAS vs CMS). Even though the first camera 104 may be properly calibrated, safety of the vehicle 100 may be further improved by the second camera 106. However, added benefits that may be provided by the second camera 106 may only be realized if the second camera 106 is also calibrated. Calibrating the second camera 106 improves the accuracy of the image information provided by the camera, which improves vehicle safety, but calibration methods may be cost-prohibitive and time-consuming. Thus, calibrating the second camera 106 would further increase the production costs of the vehicle 100.

In this regard, in an exemplary aspect, a second calibration information 118 of the second camera 106 may be generated using the first calibration information 112 of the first camera 104 in combination with translation information 120. The first calibration information 112 identifies a first position P1 of the first camera 104 and a first orientation 122 of the first camera 104 relative to a reference position PREF and a reference orientation OREF. The translation information 120 identifies a position difference 124 between the first position P1 and a second position P2 of the second camera 106, and an orientation difference 126 between the first orientation 122 of the first camera 104 and a second orientation 128 of the second camera 106. Thus, the second calibration information 118 may be generated by combining the first calibration information 112 and the translation information 120.

In addition to the first camera 104 and the second camera 106, the imaging system 102 also includes a processing circuit 130, that may be the electronic control unit (ECU) 110, for example, and may include an image signal processor (ISP) 132. The ISP 132 is programmable to execute computer instructions (e.g., software instructions, firmware instructions) for analyzing and responding to first image information 134 received from the first camera 104 and second image information 136 received from the second camera 106. The ECU 110 may communicate with the first camera 104 and the second camera 106 wirelessly or by wired connections, or both. The ECU 110 may be configured to improve safety of the vehicle 100 and nearby traffic in response to the received first and second image information 134, 136, which may include generating signals to control functions of the vehicle 100, such as warnings and information to the driver and automated driver assistance functions.

The first calibration information 112 may be used by the ECU 110 to calibrate the first camera 104, which is to adjust the first image information 134 received from the first camera 104, based on the first orientation 122, to generate a calibrated image 146 having a view corresponding to the reference position PREF and the reference orientation OREF, for example. The ECU 110 may also be configured to calibrate the second camera 106 based on the first calibration information 112. In some examples, the ECU 110 may use differences between the first image information 134 and the second image information 136 to determine the translation information 120.

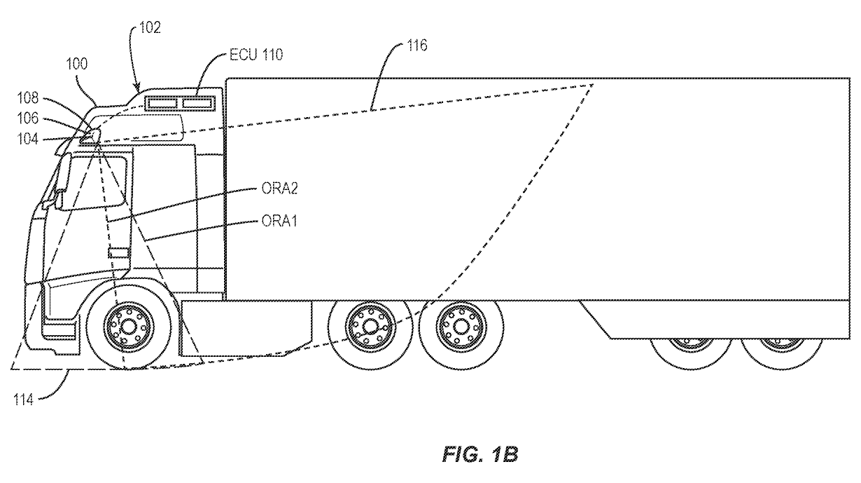

In this regard, FIG. 2 is an example of the housing 108 in FIGS. 1A-1B on a side of the vehicle 100 viewed by the first camera 104 and the second camera 106, which are collocated in the housing 108. Features of FIG. 2 that are common to features in FIGS. 1A-1B are labeled the same. In this context, the term “collocated” refers to being set or placed together, including side by side, in the housing 108. In particular, the first camera 104 being collocated with the second camera 106 indicates that they are both supported in the same housing 108 and may be similarly displaced from the reference position PREF and the reference orientation OREF. The first camera 104 and the second camera 106 disposed in the housing 108 may be separated by less than 12 inches or 30.5 centimeters, for example, and may be separated by less than 6 inches or 15.25 centimeters.

The housing 108 supports the first camera 104 fixedly in the first position P1 and supports the second camera 106 fixedly in the second position P2. The position P2 and the second orientation 128 of the second camera 106 are different from the first position P1 and the first orientation 122 of the first camera 104 as determined by their relative positions in the housing 108. The housing 108 may be any appropriate size and/or shape, such as a wing, to support the first camera 104 in the first position P1 having the first orientation 122 from which first image information 134 may be received. The housing 108 also supports the second camera 106 in the second position P2 having the second orientation 128 from which the second image information 136 may be received. The first orientation 122 and the second orientation 128 are indicated in FIG. 2 by axes ORA1 and ORA2, representing angles of view of the respective first and second cameras 104, 106. In some examples, the housing 108 may extend any appropriate distance from the vehicle 100 for an improved viewing angle and, as such, may be foldable to achieve a reduced width profile, as needed. In this regard, the second camera 106 may be disposed in a third position and a third orientation relative to the first camera, and the ECU 110 may determine new translation information for the different position based on the second image information 136 received in the second camera 106. The housing 108 may comprise a plastic or metal shell or a combination thereof to protect the first camera 104 and the second camera 106 from the elements.

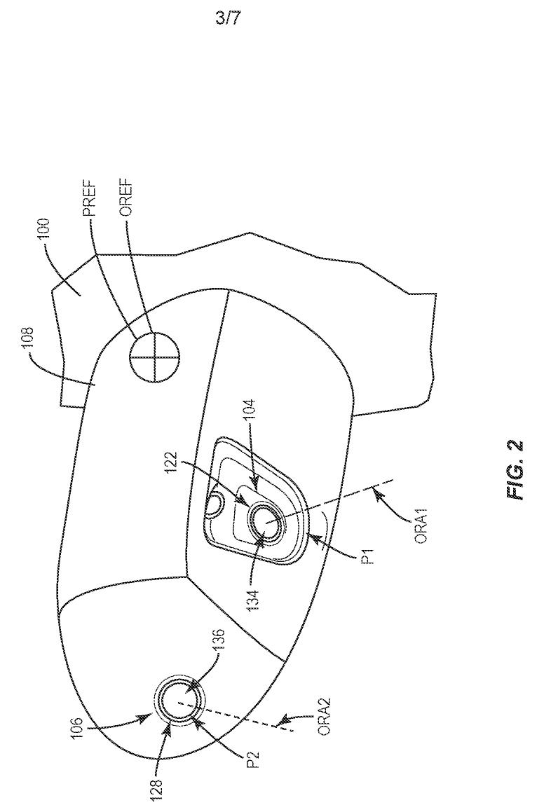

FIG. 3 is a top view of another example of the housing 108 in FIGS. 1A, 1B, and 2 including the first and second cameras 104, 106 in positions P1 and P2. The position P1 may be indicated by distances in three dimensions from a reference position PREF, which may be a fixed position relative to the vehicle 100. The position difference 124 between the position P1 of the first camera 104 and the position P2 of the second camera 106 is included in the translation information 120. The translation information 120 also includes an orientation difference 126 between the first orientation 122 of the first camera 104 and the second orientation 128 of the second camera 106. The position difference 124 may be given as distances in three dimensions. The position difference 124 shown in FIG. 3 includes a first distance 138X in an X-axis direction, a second distance 138Y in a Y-axis direction, and a third distance 138Z in a Z-axis direction (not shown). The orientation difference 126 may be given as angles including a pitch angle 140P, a yaw angle 140Y, and a roll angle 140R (not shown) between the second orientation 128 and the first orientation 122. The pitch angle 140P, yaw angle 140Y, and roll angle 140R indicate rotational angles around each of the three axes of a three-dimensional coordinate system (X-Y-Z) where the three axes are orthogonal to each other.

In FIG. 3, the first orientation 122 is illustrated as an orientation of a first axis system 142 located at the position P1 and the second orientation 128 is illustrated as an orientation of a second axis system 144 located at the position P2. In FIG. 3, the first axis system 142 and the second axis system 144 are in a same orientation, indicating that there is a position difference 124 but no orientation difference 126. Accordingly, the pitch 140P, yaw 140Y, and roll 140R angles describing the orientation difference 126 would each have a value of zero “0” degrees in this example. In some examples, the position P2 of the second camera 106 may be determined by adding the position difference 124 to the position P1, and the second orientation 128 may be determined by adding the orientation difference 126 to the first orientation 122. Accordingly, the second calibration information 118 of the second camera 106 may be determined, in some examples, by adding the translation information 120 to the first calibration information 112.

In this example, the first orientation 122 is indicated by the X-axis X1 of the first axis system 142 and the second orientation 128 is indicated by the X-axis X2 of the second axis system 144. Here, the first orientation 122 appears to be parallel to the second orientation 128 but in other examples, such as in FIG. 2, the imaging system 102 is not limited in this regard. In practice, the second axis system 144 may have a different orientation from the first axis system 142. The first orientation 122 may be specified as rotations along one or more of the X, Y, and Z axes of the first axis system 142 relative to the reference orientation OREF and the second axis system 144 may be specified as pitch 140P, yaw 140Y, and roll 140R of the second axis system 144 relative to the first axis system 142.

In this manner, the translation information 120 between the first camera 104 and the second camera 106 may be precisely specified by the position difference 124 and the orientation difference 126. Thus, the translation information 120 between the first camera 104 and the second camera 106, along with the first calibration information 112, can be used to generate the second calibration information 118 to calibrate the second camera 106.

The translation information 120 may be obtained from design information of the housing 108, which specifies the exact locations and orientations (within manufacturing tolerances) of the first camera 104 and the second camera 106 in the housing 108. Such information may be provided to and/or available from robotic manufacturing devices configured to manufacture the housing 108. The ECU 110 may extract the translation information 120 from such design information. The design information may be computer-aided design (CAD) information. Alternatively, to avoid or overcome variations in the housing 108 as manufactured and mounted to the vehicle 100 (e.g., due to manufacturing tolerances), the translation information 120 may be obtained by examining, measuring, and/or otherwise analyzing the housing 108. For example, the housing 108 may be laser-scanned to create a three-dimensional model that can be compared to the original design to evaluate manufacturing practices. Translation information 120 with a high level of precision may be obtained therefrom.

The translation information 120 may be used to generate a calibrated image 146 (not shown) based on the second image information 136 and the second calibration information 118. The calibrated image 146 provides a view to the driver or image processor from an expected perspective. The translation information 120 may be stored in and received from a memory circuit 148 that is accessible to the processing circuit 130 (ECU 110) (see FIGS. 1A-1B) to perform the calibration of the second camera 106. The translation information 120 may be received from a manufacturer or distributor of the housing 108, for example. The first calibration information 112 may be stored in and received from a memory accessible to the ECU 110. In some examples, the translation information 120 may be used to adjust the second position P2 and/or the second orientation 128 of the second camera 106 in the housing 108, if the housing 108 provides the option for such adjustments. The ECU 110 includes a memory circuit 148 that is configured to store any of the first calibration information 112, the second calibration information 118, the translation information 120, the first image information 134, the second image information 136, and the calibrated image 146.

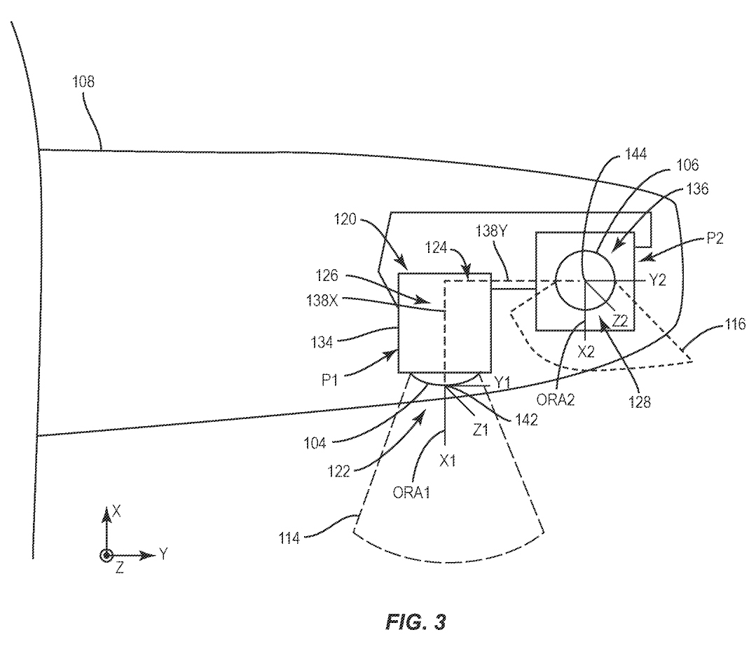

FIG. 4 is a flow chart of a method 400 of the imaging system 102 in FIGS. 1A and 1B, which may be implemented in the ECU 110. The method 400 includes receiving a first calibration information 112 for a first camera 104 disposed in a first position P1 in a housing 108 and having a first orientation 122 (block 402). The method 400 further includes receiving translation information 120 comprising a position difference 124 between the first position P1 of the first camera 104 and a second position P2 of a second camera 106 in the housing 108 and an orientation difference 126 between the first orientation 122 of the first camera 104 and a second orientation 128 of the second camera 106 (block 404). The method 400 further includes generating, based on the first calibration information 112 and the translation information 120, a second calibration information 118 for calibrating the second camera 106 (block 406). The method 400 may further include, in some examples, generating a calibrated image 146 based on the second image information 136 and the second calibration information 118 (block 408). In some examples, the method 400 may optionally include repositioning the second camera 106 to change the second orientation 128 based on the second calibration information 118.

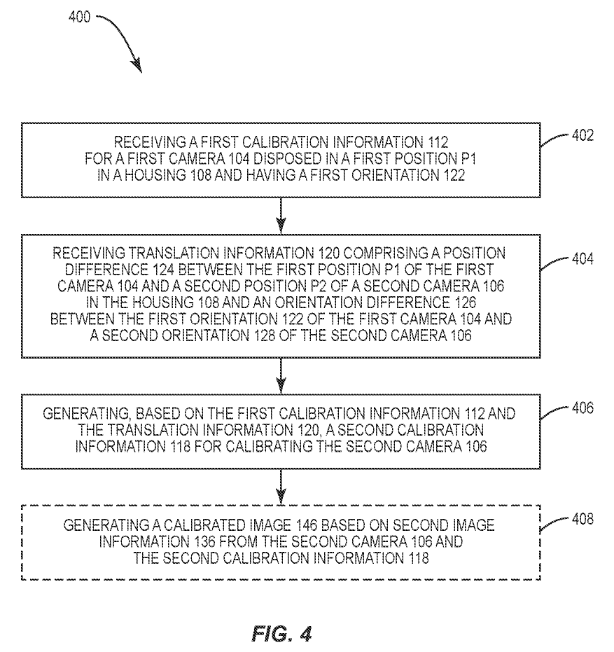

FIG. 5 shows examples of overlaid images 500L, 500R, 500U, and 500D that may be received in, for example, the first camera 104 of FIGS. 1A-3 due to variations caused by manufacturing tolerances in processes of manufacturing the housing 108. FIG. 5 is provided to illustrate the need for calibration of the first camera 104 and the second camera 106 in FIGS. 1A- 3. A target area 502 of the first camera 104 is indicated as a shaded portion. The images 500L, 500R, 500U, and 500D are each examples of image information 134 resulting from a shift in the position P1 or orientation 122 of the first camera 104, causing the target area 502 to be offset from a center of the first image information 134. FIG. 5 shows that, rather than being centered on the target area 502, the image 500L is offset to the left, the image 500R is offset to the right, the image 500U is offset upward, and the image 500D is offset downward from the target area 502. The target area 502 is included in, but not centered in, each of the images 500L, 500R, 500U, and 500D. The ECU 110 can shift the images 500L, 500R, 500U, and 500D to center the target area 502 in the calibrated image 146 based on the first calibration information 112, to ensure that a view from the first camera 104 is provided as expected. Centering a target area 502 in the calibrated image 146 may include spacing the target area by equal distances from the top and bottom and by equal distances from the left and right, for example.

Each of the images 500L, 500R, 500U, and 500D is offset from the target area 502 in only one direction, for purposes of explanation. However, the target area 502 may be offset in both the left/right direction and the up/down direction in a received image. In other examples, the image may be rotated clockwise or counterclockwise. With reference back to FIGS. 1A and 1B, the first calibration information 112 may indicate the extents and directions of offset of the image received from the first camera 104 in the ECU 110 due to imperfections in the housing 108 and/or the mounting position of the first camera 104, and the first calibration information 112 may be used in the ECU 110 to generate the calibrated image 146. In this regard, the calibrated image 146 refers to an image based on the received image but which has been shifted, rotated, and/or cropped to provide an expected view of the target area 502.

Since the position P2 and second orientation 128 of the second camera 106 may be fixed relative to the first camera 104, the first calibration information 112 is used by the ECU 110 together with the translation information 120 to identify a target area (e.g., 502) within the second image information 136 received in the second camera 106, so that the target area 502 may be optimized (e.g., centered and zoomed) for display and/or analysis. Alternatively, if the second orientation 128 of the second camera 106 is adjustable in the housing 108, the first calibration information 112 may be used together with the translation information 120 to adjust the second camera 106 so that the second orientation 128 is focused to the target area 502.

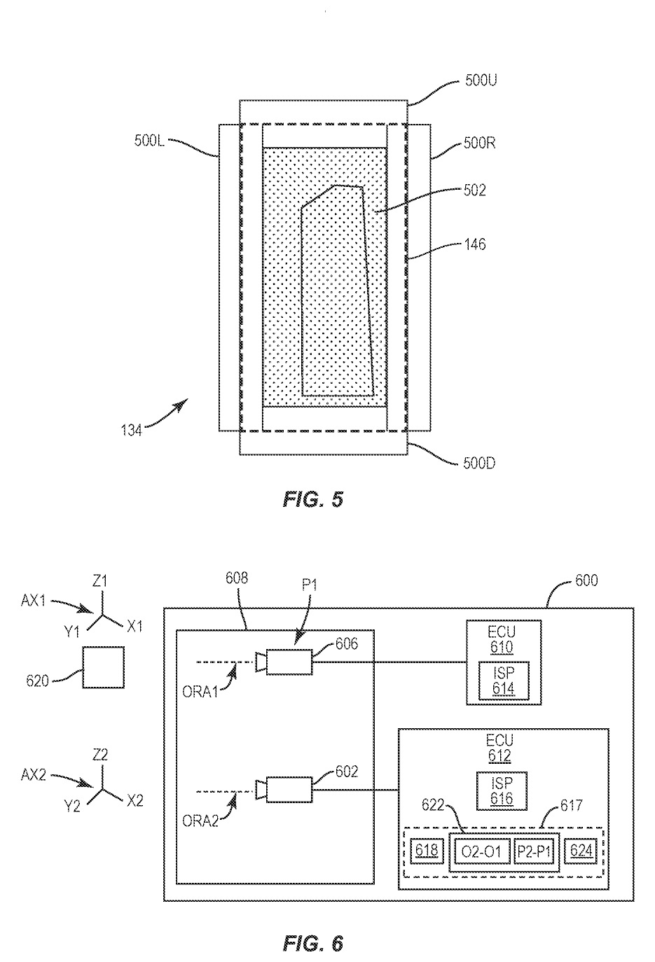

FIG. 6 is a schematic diagram of an imaging system 600 in which a second camera 602 may be calibrated based on calibration information 604 of a first camera 606 that is located in a housing 608. The imaging system 600 in this example includes a first ECU 610 coupled to the first camera 606 and a second ECU 612 coupled to the second camera 602. In some examples, the first camera 606 and the second camera 602 are both coupled to a same ECU (e.g., 612). The ECUs 610 and 612 may be the ECU 110 in FIGS. 1A and 1B. The ECUs 610, 612 include ISPs 614, 616, respectively, configured to execute software to process image information received from the first camera 606 and the second camera 602 and also to execute software to process calibration data 617 used to calibrate the first camera 606 and the second camera 602, respectively. In this example, the calibration data 617 includes first calibration information 618 for the first camera 606 based on a calibration process employing a calibration apparatus 620. The first camera 606 has a first orientation O1 and a first position P1, which may be aligned with a first axis system AX1. An orientation O2 and a second position P2 of the second camera 602 may be aligned with the second axis system AX2. The ECU 612 may receive the first calibration information 618 for the first camera 606 and receive translation information 622 indicating position differences P2-P1 and orientation differences O2-O1 between the first camera 606 and the second camera 602. The position difference P2-P1 includes distances in three dimensions between the positions P1 and P2. The orientation difference O2-O1 includes pitch, yaw, and roll angles between the first orientation O1 and the second orientation O2. Based on the first calibration information 618 and the translation information 622, the ECU 612 may generate second calibration information 628. Specifically, the ECU 612 may determine the second calibration information 628 of the second camera 602 by adding the translation information 622 to the first calibration information 618.

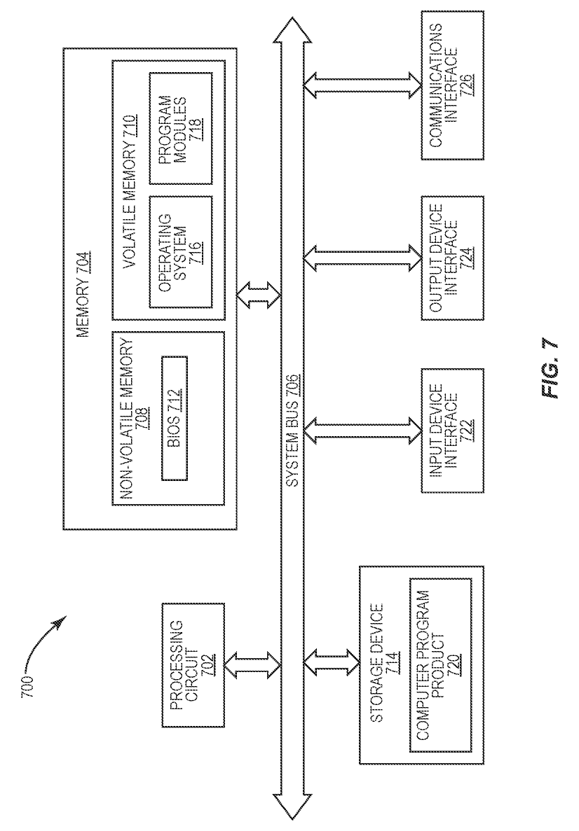

FIG. 7 is a schematic diagram of a computer system 700 that may be the ECU 110 in FIGS. 1A and 1B or the ECUs 610, 612 in FIG. 6 for implementing examples disclosed herein. The computer system 700 is adapted to execute instructions from a computer-readable medium to perform these and/or any of the functions or processing described herein. The computer system 700 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include processing circuit 702 (e.g., processing circuitry including one or more processor devices or control units), a memory 704, and a system bus 706. The computer system 700 may include at least one computing device having the processing circuit 702. The system bus 706 provides an interface for system components including, but not limited to, the memory 704 and the processing circuit 702. The processing circuit 702 may include any number of hardware components for conducting data or signal processing or for executing computer code stored in memory 704. The processing circuit 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuit 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processing circuit 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuit 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like. The non-transitory computer-readable

Computer-code which is hard or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuit 702 to carry out actions described herein. Thus, the computer-readable program code of the computer program 720 can comprise software instructions for implementing the functionality of the examples described herein when executed by the processing circuit 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuit 702. The processing circuit 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuit 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Implementation examples are described in the following numbered clauses: Example 1: A vehicle comprising an imaging system, comprising: a housing mounted to the vehicle; a first camera disposed in a first position in the housing and a first orientation relative to the first position; a second camera disposed in a second position in the housing and a second orientation relative to the second position; and a processing circuit configured to: receive a first calibration information for the first camera; receive translation information comprising: a position difference between the first position of the first camera and the second position of the second camera; and an orientation difference between the first orientation and the second orientation; and generate, based on the first calibration information and the translation information, a second calibration information for calibrating the second camera.

Example 2: The vehicle of Example 1, wherein: the second camera is configured to receive second image information; and the processing circuit is further configured to: generate calibrated second image information based on the second image information and the second calibration information.

Example 3: The device of Example 2, wherein the processing circuit is further configured to: generate the calibrated second image comprising a target area of the second image information; and center the target area in the calibrated image based on the second calibration information.

Example 4: The device of Example 1, wherein: the first camera comprises an advanced driving assistance system (ADAS) camera; and the second camera comprises a camera-monitor system (CMS) camera.

Example 5: The device of Example 1, wherein wherein the translation information comprises design information for manufacturing the housing.

Example 6: The device of Example 2, wherein the processing circuit is further configured to: receive first image information from the first camera; and generate the translation information based on the first image information and the second image information.

Example 7: The device of Example 2, wherein: the position difference comprises distances in three directions that are orthogonal to each other between the first position and the second position.

Example 8: The device of Example 1, wherein: the orientation difference comprises a pitch angle, a yaw angle, and a roll angle between the first orientation and the second orientation.

Example 9: The device of Example 1, wherein the second position of the second camera comprises: a position difference between the first position of the first camera and a reference position; and a position difference between the second position of the second camera and the first position of the first camera.

Example 10: The device of Example 1, wherein the second orientation of the second camera comprises: an orientation difference between the first camera and a reference orientation; and an orientation difference between the second camera and the first camera.

Example 11: The device of Example 1, wherein the housing is attached to one of a driver side and a passenger side of the vehicle.

Example 12: A method for calibrating a camera, comprising: receiving a first calibration information for a first camera disposed in a first position in a housing and having a first orientation; receiving translation information comprising: a position difference between the first position of the first camera and a second position of a second camera disposed in the housing; and an orientation difference between the first orientation of the first camera and a second orientation of the second camera; and generating, based on the first calibration information and the translation information, a second calibration information for calibrating the second camera.

Example 13: The method of Example 12, further comprising: receiving a second image information from the second camera; and generating a calibrated image based on the second image information and the second calibration information.

Example 14: The method of Example 13, further comprising: generating the calibrated image based on a target area of the second image information; and centering the target area in the calibrated image based on the second calibration information.

Example 15: The method of Example 12, further comprising extracting the translation information from design information for manufacturing the housing.

Example 16: The method of Example 12, further comprising examining the housing to determine the translation information.

Example 17: The method of Example 12, further comprising determining the translation information based on differences between the first image information and the second image information.

Example 18: The method of Example 12, further comprising determining the second position of the second camera, comprising: determining a position difference between the first position of the first camera and a reference position; and determining a position difference between the second position of the second camera and the first position of the first camera.

Example 19: The method of Example 12, further comprising determining the second orientation, comprising of the second camera: determining an orientation difference between the first camera and a reference orientation; and determining an orientation difference between the second camera and the first camera.

Example 20: A non-transitory computer-readable storage medium comprising instructions, which when executed by processing circuit, cause the processing circuit to: receive a first calibration information for a first camera disposed in a first position in a housing and having a first orientation; receive translation information comprising: a position difference between the first position of the first camera and a second position of a second camera disposed in the housing; and an orientation difference between the first orientation of the first camera and a second orientation of the second camera; and generate, based on the first calibration information and the translation information, a second calibration information for calibrating the second camera.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A vehicle comprising an imaging system, comprising:
a housing mounted to the vehicle;
a first camera disposed in a first position in the housing and a first orientation relative to the first position;
a second camera disposed in a second position in the housing and a second orientation relative to the second position; and
a processing circuitry configured to:
receive a first calibration information for the first camera;
receive translation information comprising:
a position difference between the first position of the first camera and the second position of the second camera; and
an orientation difference between the first orientation and the second orientation; and
generate, based on the first calibration information and the translation information, a second calibration information for calibrating the second camera.

2. The vehicle of claim 1, wherein:
the second camera is configured to receive second image information; and
the processing circuitry is further configured to:
generate calibrated second image information based on the second image information and the second calibration information.

3. The vehicle of claim 2, wherein the processing circuitry is further configured to:
generate the calibrated second image comprising a target area of the second image information; and
center the target area in the calibrated image based on the second calibration information.

4. The vehicle of claim 1, wherein:
the first camera comprises an advanced driving assistance system (ADAS) camera; and
the second camera comprises a camera-monitor system (CMS) camera.

5. The vehicle of claim 1, wherein the translation information comprises design information for manufacturing the housing.

6. The vehicle of claim 2, wherein the processing circuitry is further configured to:
receive first image information from the first camera; and
generate the translation information based on the first image information and the second image information.

7. The vehicle of claim 2, wherein:
the position difference comprises distances in three directions that are orthogonal to each other between the first position and the second position.

8. The vehicle of claim 1, wherein:
the orientation difference comprises a pitch angle, a yaw angle, and a roll angle between the first orientation and the second orientation.

9. The vehicle of claim 1, wherein the second position of the second camera comprises:
a position difference between the first position of the first camera and a reference position; and
a position difference between the second position of the second camera and the first position of the first camera.

10. The vehicle of claim 1, wherein the second orientation of the second camera comprises:
an orientation difference between the first camera and a reference orientation; and
an orientation difference between the second camera and the first camera.

11. The vehicle of claim 1, wherein the housing is attached to one of a driver side and a passenger side of the vehicle.

12. A method for calibrating a camera, comprising:
receiving a first calibration information for a first camera disposed in a first position in a housing and having a first orientation;
receiving translation information comprising:
a position difference between the first position of the first camera and a second position of a second camera disposed in the housing; and
an orientation difference between the first orientation of the first camera and a second orientation of the second camera; and
generating, based on the first calibration information and the translation information, a second calibration information for calibrating the second camera.

13. The method of claim 12, further comprising:
receiving a second image information from the second camera; and
generating a calibrated image based on the second image information and the second calibration information.

14. The method of claim 13, further comprising:
generating the calibrated image based on a target area of the second image information; and
centering the target area in the calibrated image based on the second calibration information.

15. The method of claim 12, further comprising extracting the translation information from design information for manufacturing the housing.

16. The method of claim 12, further comprising examining the housing to determine the translation information.

17. The method of claim 12, further comprising determining the translation information based on differences between the first image information and the second image information.

18. The method of claim 12, further comprising determining the second position of the second camera, comprising:
determining a position difference between the first position of the first camera and a reference position; and
determining a position difference between the second position of the second camera and the first position of the first camera.

19. The method of claim 12, further comprising determining the second orientation, comprising of the second camera:
determining an orientation difference between the first camera and a reference orientation; and
determining an orientation difference between the second camera and the first camera.

20. A non-transitory computer-readable storage medium comprising instructions, which when executed by processing circuitry, cause the processing circuitry to:
receive a first calibration information for a first camera disposed in a first position in a housing and having a first orientation;
receive translation information comprising:
a position difference between the first position of the first camera and a second position of a second camera disposed in the housing; and
an orientation difference between the first orientation of the first camera and a second orientation of the second camera; and
generate, based on the first calibration information and the translation information, a second calibration information for calibrating the second camera.
